(19) United States
(12) Patent Application Publication
(10) Pub. No.: US 2011/0135008 A1
(43) Pub. Date: Jun. 9, 2011

(54) VIDEO PROCESSING SYSTEM

(75) Inventors: Jin Ho HAN, Seoul (KR); Kyoung Seon Shin, Daejeon (KR)

(73) Assignee: ELECTRONICS AND TELECOMMUNICATIONS RESEARCH INSTITUTE, Daejeon (KR)

(21) Appl. No.: 12/961,196

(22) Filed: Dec. 6, 2010

(30) Foreign Application Priority Data
Dec. 7, 2009 (KR) 10-2009-0120355
Nov. 22, 2010 (KR) 10-2010-0116380

(51) Int. Cl. H04N 7/30

(52) U.S. Cl. 375/240.24; 375/E07.226

(57) ABSTRACT

A video processing system includes a frame memory, an input video buffer, a macroblock buffer, a first search window buffer, a second search window buffer, a deblocked macroblock buffer, and a frame memory controller. The frame memory stores frame data. The input video buffer stores input data and transfers the input data to the frame memory. The macroblock buffer stores a plurality of macroblocks. The first search window buffer stores a search region of a reference frame for coarse motion estimation. The second search window buffer stores a search region of a reference frame for fine motion estimation. The deblocked macroblock buffer stores the performance results of a deblocking filter. The frame memory controller performs write/read operations on the input video buffer, the macroblock buffer, the first search window buffer, the second search window buffer, the deblocked macroblock buffer and the frame memory.

### CROSS-REFERENCE TO RELATED APPLICATIONS

This application claims the priority of Korean Patent Application No. 10-2009-0120355 filed on Dec. 7, 2009 and 10-2010-0116380 filed on Nov. 22, 2010, in the Korean Intellectual Property Office, the disclosure of which is incorporated herein by reference.

### BACKGROUND OF THE INVENTION

1. Field of the Invention

The present invention relates to a video processing system, and more particularly, to a video processing system that can reduce an execution cycle per macroblock.

2. Description of the Related Art

In general, due to the large amount of pieces of frame data to be processed in video processing, a video encoder stores data in a frame memory such as a synchronous dynamic random access memory (SDRAM) and only transfers necessary frame data to a specific buffer in an encoder.

Recently developed standard video coding techniques are difficult to apply to real-time applications, because they require a large memory bandwidth and have a high operational complexity. In particular, because motion estimation is performed by the ¼ pixel unit that is more complex than the conventional ½ pixel unit, there is an increasing need to read a large amount of data from a frame memory according to a pixel interpolation scheme and a motion estimation scheme. Also, as the size of data contained within a video increases, the data transmission rate between a frame memory and a buffer in an encoder greatly affects the performance of the encoder.

### SUMMARY OF THE INVENTION

An aspect of the present invention provides a video processing system that can reduce an execution cycle per macroblock.

According to an aspect of the present invention, there is provided a video processing system including: a frame memory configured to store frame data; an input video buffer configured to store input data and transfer the input data to the frame memory; a macroblock (MB) buffer configured to store a plurality of macroblocks; a first search window (SW) buffer configured to store a search region of a reference frame for coarse motion estimation (CME); a second search window (SW) buffer configured to store a search region of a reference frame for fine motion estimation (FME); a deblocked macroblock buffer configured to store the performance results of a deblocking filter; and a frame memory controller configured to perform write/read operations on the input video buffer, the macroblock buffer, the first search window buffer, the second search window buffer, the deblocked macroblock buffer and the frame memory.

The frame memory may include a synchronous dynamic random access memory (SDRAM).

The input video buffer may store the input data by dividing the input data by the number of macroblocks in a frame.

The macroblock buffer may be configured to sequentially store a plurality of macroblocks read from the frame memory and to sequentially read the stored macroblocks.

The macroblock buffer may include a plurality of memories, and each of the memories may be configured to store the chroma and the luminance of a macroblock.

The size of a search region of each reference frame in the first search window buffer may be variable.

The search regions of the reference frames may be simultaneously read from the first search window buffer.

The second search window buffer may store the search regions of the reference frames other than those of the first search window buffer.

The search regions of the reference frames other than those of the first search window buffer may vary according to the results of coarse motion estimation (CME).

The performance results of the deblocking filter in the deblocked macroblock buffer may be stored in the frame memory.

The frame memory controller may be configured to perform a data write/read operation on a macroblock basis.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a video processing system according to an exemplary embodiment of the present invention;

FIG. 2 is an interface diagram illustrating a frame memory controller according to an exemplary embodiment of the present invention;

FIG. 3 is a block diagram of a frame memory controller according to an exemplary embodiment of the present invention;

FIG. 4 is an interface diagram illustrating an input video buffer according to an exemplary embodiment of the present invention;

FIG. 5 is a block diagram of an input video buffer according to an exemplary embodiment of the present invention;

FIG. 6 is an interface diagram illustrating a macroblock buffer according to an exemplary embodiment of the present invention;

FIG. 7 is a block diagram of a macroblock buffer according to an exemplary embodiment of the present invention;

FIG. 8 is a diagram illustrating an operation of a macroblock buffer according to an exemplary embodiment of the present invention;

FIG. 9 is an interface diagram illustrating a first search window buffer according to an exemplary embodiment of the present invention;

FIG. 10 is a block diagram of a first search window buffer according to an exemplary embodiment of the present invention;

FIG. 11 is a diagram illustrating an operation of a first search window buffer according to an exemplary embodiment of the present invention;

FIG. 12 is another diagram illustrating an operation of a first search window buffer according to an exemplary embodiment of the present invention;

FIG. 13 is another diagram illustrating an operation of a first search window buffer according to an exemplary embodiment of the present invention;

FIG. 14 is an interface diagram illustrating a second search window buffer according to an exemplary embodiment of the present invention;

FIG. 15 is a block diagram of a second search window buffer according to an exemplary embodiment of the present invention;

FIG. 16 is a diagram illustrating an operation of a second search window buffer according to an exemplary embodiment of the present invention;

FIG. 17 is an interface diagram illustrating a deblocked macroblock (MB) buffer according to an exemplary embodiment of the present invention;

FIG. 18 is a block diagram of a deblocked macroblock (MB) buffer according to an exemplary embodiment of the present invention; and

FIG. 19 is a diagram illustrating a stage-by-stage operation of a video processing system according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

It will be apparent to those skilled in the art that various modifications and variations can be made in the present invention without departing form the spirit or scope of the invention.

Thus, it is intended that the present invention cover all possible modifications and variations of this invention, provided they come within the scope of the appended claims and their equivalents.

Also, even though terms like a first and a second may be used to describe various components in various embodiments of the present invention, the components or elements are not limited by these terms. These terms are used only to differentiate one component from another. Therefore, a component referred to as a first component in one embodiment may be referred to as a second component in another embodiment. As used herein, the term and/or includes any and all combinations of one or more of the associated listed items.

Also, when one component is referred to as being “connected/coupled” to another component, it should be understood that the former may be “directly connected” to the latter, or “indirectly connected” to the latter through at least one intervening component. In contrast, when a component is referred to as being “directly connected to” or “directly coupled to” another component, there are no intervening components present.

The terminology used herein is for the purpose of describing particular embodiments only and is not intended to limit the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by those skilled in the art to which the present invention pertains. It will be further understood that terms, such as those defined in commonly used dictionaries, should be interpreted as having meanings which are consistent with their meanings in the context of the relevant art and will not be interpreted in an idealized or overly formal sense unless expressly so defined herein.

Hereinafter, exemplary embodiments of the present invention will be described in detail with reference to the accompanying drawings. Like reference numerals in the drawings denote like elements, and thus their description will be omitted for conciseness.

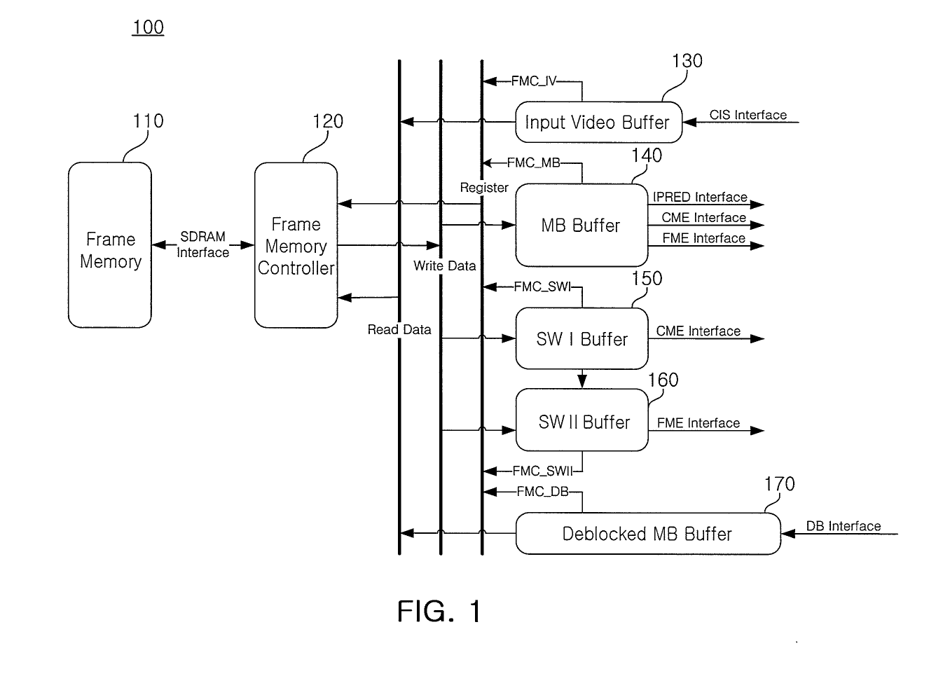

FIG. 1 is a block diagram of a video processing system according to an exemplary embodiment of the present invention.

Referring to FIG. 1, a video processing system 100 according to an exemplary embodiment of the present invention may include a frame memory 110, an input video buffer 130, a macroblock (MB) buffer 140, a first search window (SW 1) buffer 150, a second search window (SW 2) buffer 160, a deblocked macroblock buffer 170, and a frame memory controller 120. The frame memory 110 is configured to store frame data. The input video buffer 130 is configured to store input data and transfer the input data to the frame memory. The macroblock (MB) buffer 140 is configured to store a plurality of macroblocks. The first search window (SW 1) buffer 150 is configured to store a search region of a reference frame for coarse motion estimation (CME). The second search window (SW 2) buffer 160 is configured to store a search region of a reference frame for fine motion estimation (FME). The deblocked macroblock buffer 170 is configured to store the performance results of a deblocking filter. The frame memory controller 120 is configured to perform write/read operations on the input video buffer 130, the macroblock buffer 140, the first search window buffer 150, the second search window buffer 160, the deblocked macroblock buffer 170 and the frame memory 110.

The video processing system 100 may further include three buses: a read data bus, a write data bus, and a register bus.

Referring to FIG. 1, the video processing system 100 operates as follows.

The frame data stored in the frame memory 110 through the input video buffer 130 are read on a 16×16 macroblock basis and are stored in the macroblock buffer 140. Also, the macroblock stored may be used to perform an intra prediction (IPRED) operation, a coarse motion estimation (CME) operation and a fine motion estimation (FME) operation.

Among the reference frame regions of the current frame, a search region of a reference frame for coarse motion estimation may be stored in the first search window buffer 150.

The search region of the reference frame for coarse motion estimation, stored in the first search window buffer 150, and the macroblock stored in the macroblock buffer 140 may be used to perform a coarse motion estimation operation and output a motion vector.

The search region of the reference frame for fine motion estimation, calculated by using the motion vector that is the output of the coarse motion estimation operation, are stored in the second search window buffer 160.

The search region of the reference frame for fine motion estimation, stored in the second search window buffer 160, the search region of the reference frame for coarse motion estimation, stored in the first search window buffer 150, and the macroblock stored in the macroblock buffer 140 are used to output a motion vector and a predicted macroblock in the fine motion estimation operation.

The motion vector outputted by the fine motion estimation operation and the macroblock stored in the macroblock buffer 140 are used to perform intra prediction, Hadamard transform, discrete cosine transform (DCT), and quantization. A context adaptive variable length coding (CAVLC) operation is performed on the performance results of the intra prediction, Hadamard transform, discrete cosine transform (DCT) and quantization to output a compressed video.

Inverse discrete cosine transform (IDCT), inverse Hadamard transform, and reconstruction are performed on the performance results of the intra prediction, Hadamard transform, discrete cosine transform (DCT) and quantization, and the results thereof are deblocked by the deblocking filter and are stored in the deblocked macroblock buffer 170.

The deblocked macroblock stored in the deblocked macroblock buffer 170 is stored in the frame memory 110.

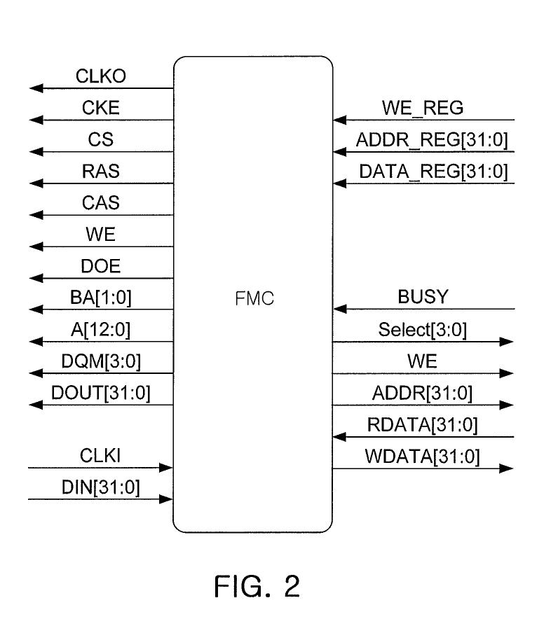

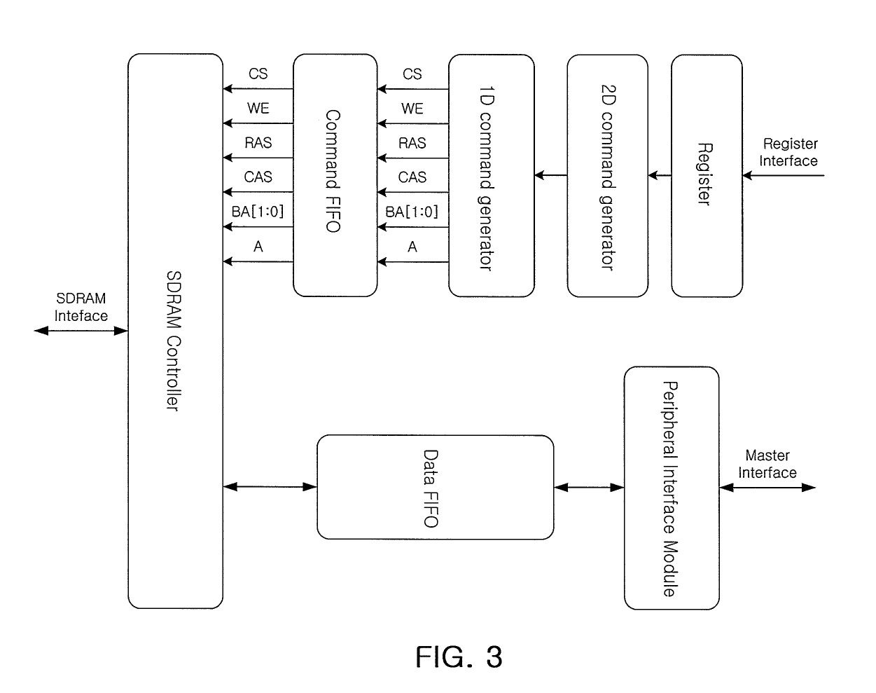

FIG. 2 is an interface diagram illustrating a frame memory controller according to an exemplary embodiment of the present invention. FIG. 3 is a block diagram of a frame memory controller according to an exemplary embodiment of the present invention.

Referring to FIGS. 2 and 3, a frame memory controller 120 according to an exemplary embodiment of the present invention may be configured to perform a data write/read operation on a macroblock basis. That is, the frame memory controller 120 may be configured to rapidly perform a macroblock-based write/read operation on macroblock-based data.

The frame memory controller 120 performs a read operation and a write operation on the input video buffer 130, the macroblock buffer 140, the first search window buffer 150, the second search window buffer 160, the deblocked macroblock buffer 170 and the frame memory 110.

The frame memory controller 120 is set through the register bus, and performs a data write/read operation through the write data bus and the read data bus.

The frame memory controller 120 may use an SDRAM as a frame memory. Therefore, in addition to a data transmission part, the frame memory controller 120 may support: an SDRM control function for using a refresh operation, a precharge operation, and a bank interleaving operation; a direct memory access function for performing transmission between memories by notifying a source memory region and a destination memory region by the buffer without performing transmission between the buffers and the frame memory; and a 2D transmission function for performing rapid data transmission on a macroblock basis due to the characteristics of a video encoder.

Referring to FIG. 2, the interface of the frame memory controller 120 according to an exemplary embodiment of the present invention is as follows.

CLKO, CKE, CS, RAS, CAS, WE, DOE, BA[1:0], A[12:0], DQM[3:0], DOUT[31:0], CLKI, and DIN[31:0] area JDEC standard SDRAM interface. WE_REG, ADDR_REG[31:0] and DATA_REG[31:0] are a frame memory controller register interface, in which a signal is transferred from each buffer through a register buffer. BUSY, Select[3:0], WE, ADDR[31:0], RDATA[31:0], and WDATA[31:0] are signals for reading/writing a memory in each buffer.

Referring to FIG. 3, the internal structure of the frame memory controller 120 according to an exemplary embodiment of the present invention is as follows.

Together with data transmission, an SDRAM controller transmits a command according to a register value to perform an SDRAM control.

A command FIFO stores a source address and a destination address according to a register value, and sequentially provides the source address and the destination address to the SDRAM controller.

A first command generator receives a start address and an end address of the source and destination from a second command generator, and sequentially generates the corresponding SDRAM interface signals.

In a 2D block transmission mode, the second command generator transmits a start address and an end address for various ID transmissions to the first command generator.

A peripheral interface module stores a peripheral address received from the command FIFO and data received from the data FIFO in a buffer through a master interface, and stores data received from the buffer through the master interface and an SDRAM interface signal received from the command FIFO in the data FIFO.

The data FIFO stores control signals, addresses and data transmitted between the SDRAM controller and the peripheral interface module, and sequentially transmits the same to the SDRAM controller or the peripheral interface module when requested.

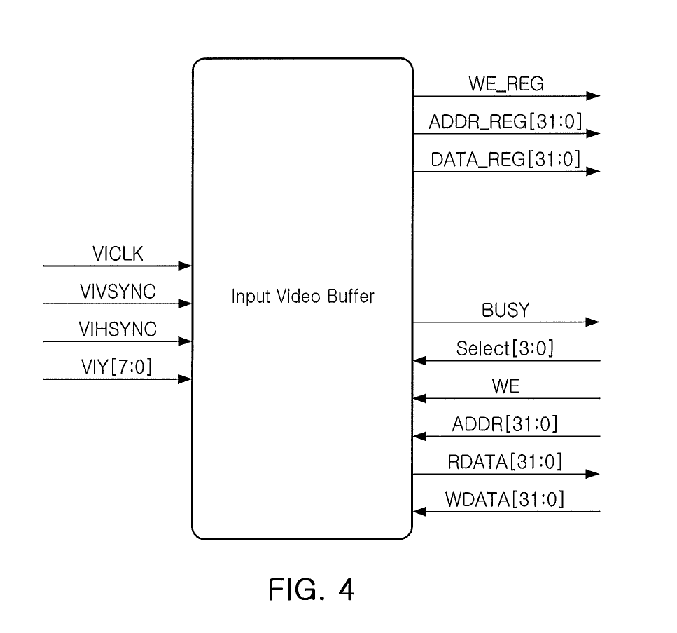

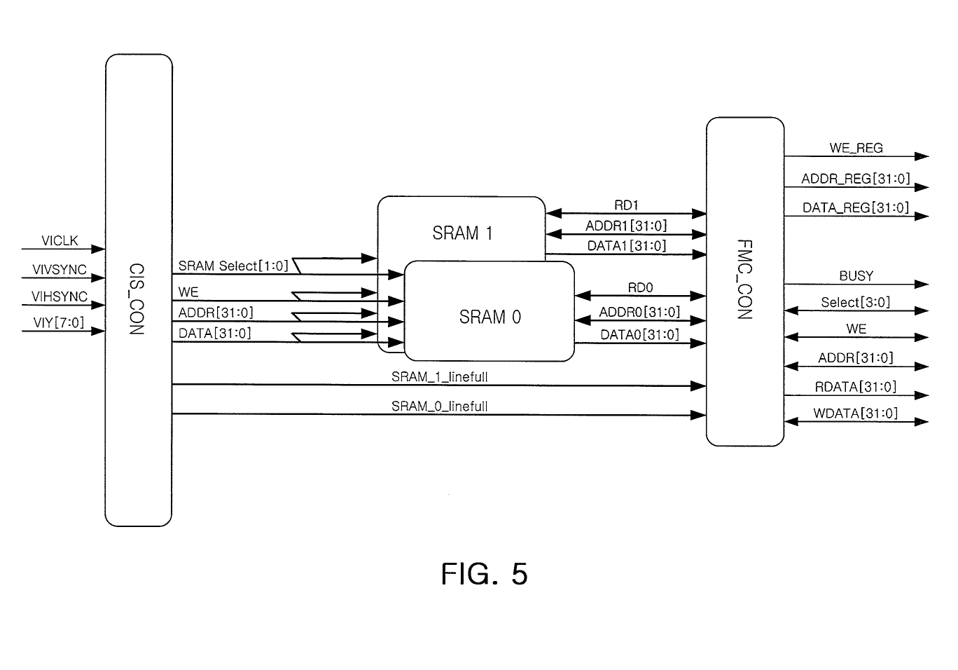

FIG. 4 is an interface diagram illustrating an input video buffer according to an exemplary embodiment of the present invention. FIG. 5 is a block diagram of an input video buffer according to an exemplary embodiment of the present invention.

Referring to FIGS. 4 and 5, an input video buffer 130 according to an exemplary embodiment of the present invention is configured to store input data and transfer the same to the frame memory. The input video buffer 130 may store the input data by dividing the input data by the number of macroblocks in a frame.

The input video buffer 130 stores input video and transmits the stored video through the frame memory controller 120 to the frame memory 110.

An input video having a YUV format is unilaterally inputted through a camera interface in accordance with a video size and the number of frames per second. The frame memory controller may be used by another buffer. In this case, the input video cannot be stored in the frame memory according to the state of the frame memory controller. Therefore, the frame memory controller stores the input video in the memory of an input video buffer, divides the stored input video by the number of macroblocks in a frame, and stores the same in the frame memory through the frame memory controller, thus maintaining the number of process cycles per macroblocks.

Referring to FIGS. 4 and 5, the interface signals of the input video buffer according to an exemplary embodiment of the present invention are as follows.

CIS_CON receives camera input and stores the same in a memory of an effective SRAM 0/1 on a line basis. SRAM0 and SRAM have a size capable of storing the luma (luminance) and chroma (chrominance) values of 1 line. FMC_CON reads a memory with a line filled and transmits the stored line data to the frame memory through frame memory controller setting.

A YUV format video is inputted through VICLK, VIVSYNC, VIHSYNC, and VIY[7:0] and is stored in an internal memory. There is a case in which a chroma value is included according to a video format in which the video is inputted on a line basis in a frame. Thus, the SRAM0/SRAM1 has a size capable of storing 1 line of chroma and luma of a maximum video size. Herein, while the next line is being stored in the SRAM after one line is stored in the SRAM0, data corresponding to a micro block is stored in the frame memory by the FMC_CON in the case of the line in the SRAM0.

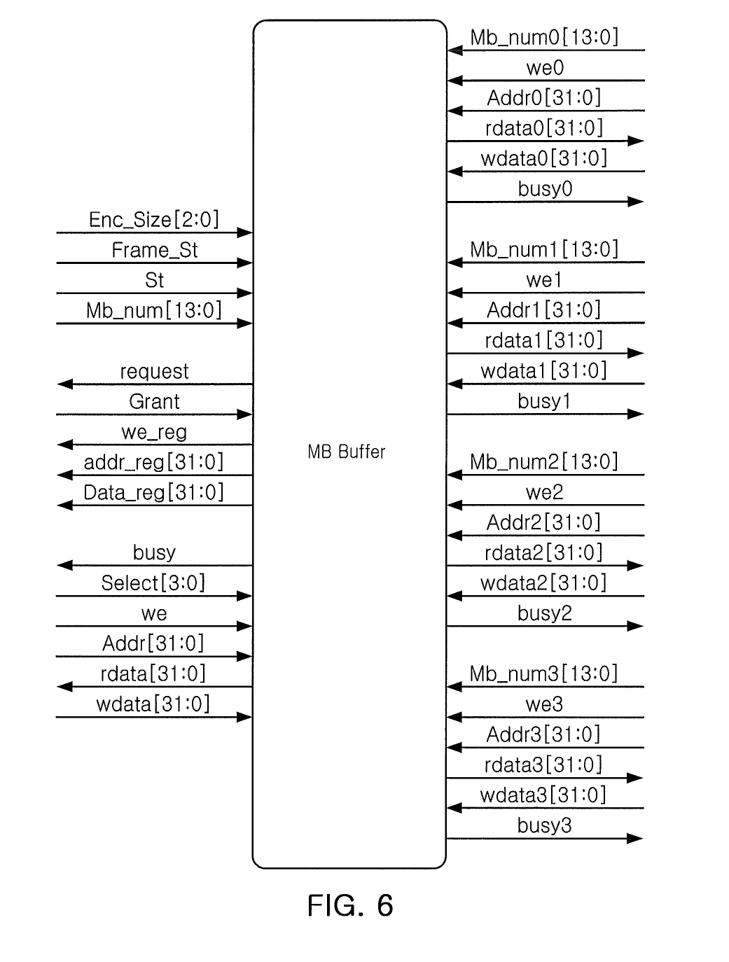

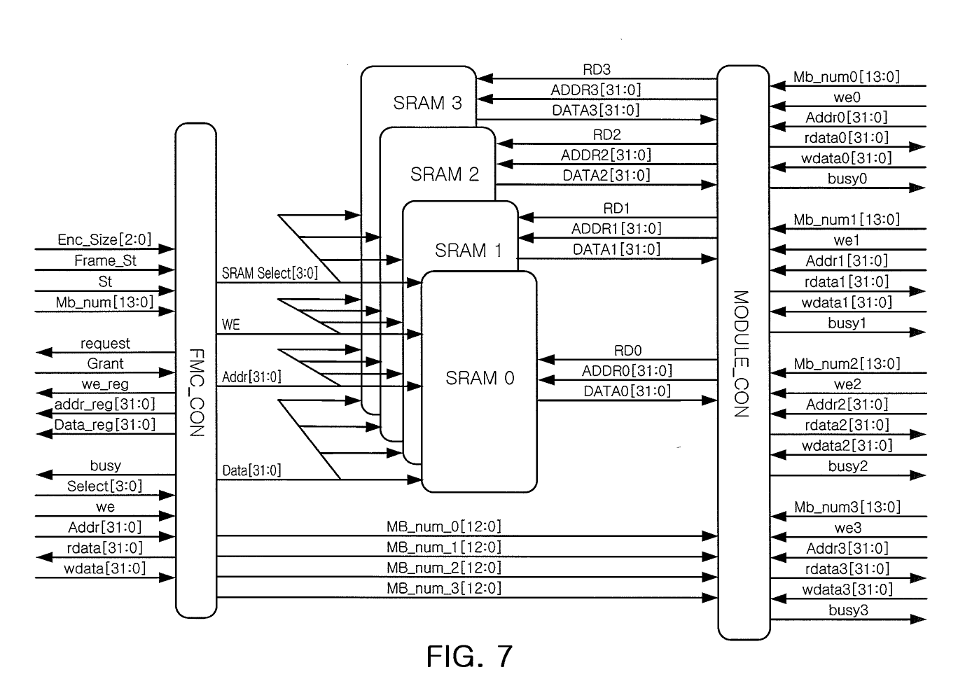

FIG. 6 is an interface diagram illustrating a macroblock buffer according to an exemplary embodiment of the present invention. FIG. 7 is a block diagram of a macroblock buffer according to an exemplary embodiment of the present invention.

Referring to FIGS. 6 and 7, a macroblock buffer 140 according to an exemplary embodiment of the present invention may be configured to sequentially store a plurality of macroblocks read from the frame memory and to sequentially read the stored macroblocks.

In the current frame, video data corresponding to a macroblock are sequentially read from the frame memory 110 and simultaneously-read N macroblocks are stored. Therefore, the internal function blocks requiring the macroblocks may simultaneously read the corresponding macroblocks.

The macroblock buffer includes N memories, and one memory can store the chroma and luma of a macroblock. The macroblock buffer has an independent port and has an index of a macroblock stored therein. Thus, the internal block requiring this may read according to the corresponding index. Also, a plurality of blocks may simultaneously read macroblocks of different indexes.

Referring to FIGS. 6 and 7, the internal block and the interface signals of the macroblock buffer 140 according to an exemplary embodiment of the present invention are as follows.

There may be N SRAMs for an internal memory. Herein, it is assumed that N is 4. The SRAM0 stores an (N+1) to macroblock that will be used by the frame memory controller to perform the next coarse motion estimation operation. The SRAM1 having an N^{th} macroblock stored by the frame memory controller is used to perform a coarse motion estimation operation. The SRAM2 having an (N−1)^{th} macroblock stored therein is used to perform an intra prediction operation. The SRAM3 having an (N−2)^{th} macroblock stored therein is used to perform a fine motion estimation operation.

The SRAM3 having a stored (N−2)^{th}macroblock that is not used any more stores an (N+2)^{th} macroblock by the frame memory controller. Coarse motion estimation uses the SRAM0 having an (N+1)^{th} macroblock stored therein. The SRAM1 having an N^{th} macroblock stored therein is used in intra prediction, and fine motion estimation uses the SRAM2 having an (N−1) macroblock stored therein.

In the next step, the frame memory controller stores a new macroblock by detecting an SRAM having a stored macroblock that is no longer in use.

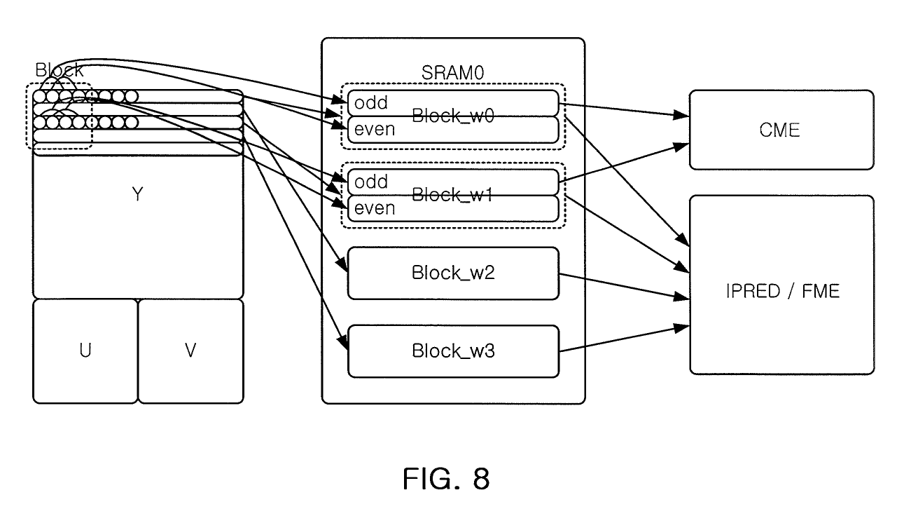

FIG. 8 is a diagram illustrating an operation of a macroblock buffer according to an exemplary embodiment of the present invention.

Referring to FIG. 8, a macroblock buffer 140 according to an exemplary embodiment of the present invention is configured to efficiently read blocks by SRAMs 0-3.

The SRAM in the macroblock buffer 140 is divided into Block_w0, Block_w1, Block_w2, and Block_w3, and 4 words of a block in the macroblock are stored in a divided manner. Thus, they can simultaneously read one block, so that the blocks performing a block-by-block process can simultaneously read/process one block.

Also, coarse motion estimation does not perform a motion prediction operation on pixels corresponding to a 16×16 matrix corresponding to a conventional macroblock size, but performs a motion prediction operation on pixels corresponding to an 8×8 matrix resulting from a ½ sampling operation. Thus, the pixels read from an external memory are divided into valid pixels and invalid pixels, and they are stored in different memories.

That is, among the 4 pixels on the same line in a block, the first pixel and the second pixel are stored in an odd memory and the second pixel and the fourth pixel are stored in an even memory.

Coarse motion estimation uses only odd SRAMs in Block_w0 and Block_w1 when reading a macroblock, and obtains four valid pixels including pixels of a neighbor block stored in Block_w0 and Block_w1 when reading on a word basis. The odd/even memories may be read on a half-word basis so that a read operation may be performed on a word basis when Block_w0 and Block_w1 are used in intra prediction (IPRED) or fine motion estimation (FME), even when it is configured with Block_w0 and Block_w1.

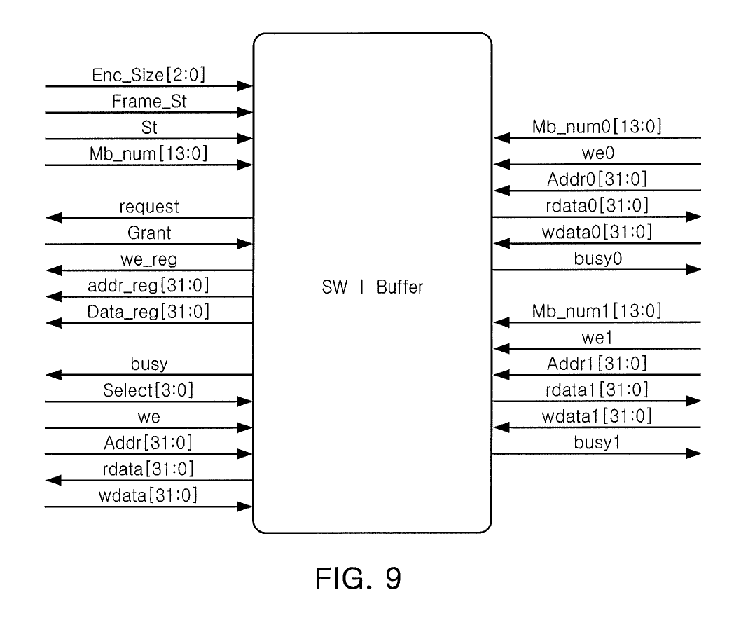

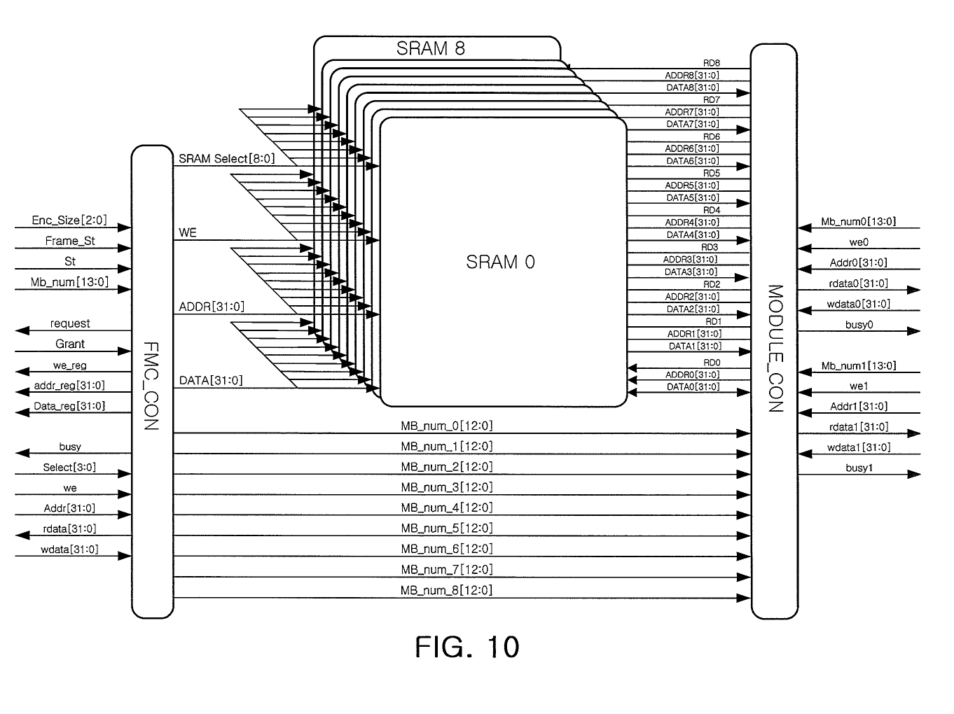

FIG. 9 is an interface diagram illustrating a first search window buffer according to an exemplary embodiment of the present invention. FIG. 10 is a block diagram of a first search window buffer according to an exemplary embodiment of the present invention.

Referring to FIGS. 9 and 10, a first search window buffer 150 according to an exemplary embodiment of the present invention is configured to store a search region of a reference frame for coarse motion estimation. The size of a search region of each reference frame in the first search window buffer may be variable. The search regions of the reference frames may be simultaneously read from the first search window buffer.

For inter prediction, a region of the previous frame is used to perform motion estimation. To this end, a region of the previous frame, that is, a search region (SW I) for coarse motion estimation of hierarchical motion estimation among the search windows is stored, and it means a function that enables a coarse motion estimation function block and a fine motion estimation function block to read the stored search region (SW I) of the reference frame for coarse motion estimation.

Referring to FIGS. 9 and 10, the block diagram and the interface signals of the first search window buffer according to an exemplary embodiment of the present invention are as follows.

The first search window buffer 150 may include N SRAMS, and the size of a search region (SW I) of a reference frame for coarse motion estimation may be variable.

Herein, when motion estimation of fine motion estimation is divided into several steps, the motion estimation blocks the respective steps are configured to simultaneously read the search region (SW I) of the reference frame for coarse motion estimation of different macroblocks.

In operation, the search window (SW) corresponds to 48×48 pixels that are equal to 9 macroblocks from the center of the macroblock, and motion estimation performs hierarchical motion estimation. Therefore, the motion estimation may be divided into coarse motion estimation and fine motion estimation. The search region (SW I) of the reference frame for coarse motion estimation stores a search window of the reference frame for coarse motion estimation. Based on this, it may be applicable to an inter prediction scheme that performs multi-step motion estimations.

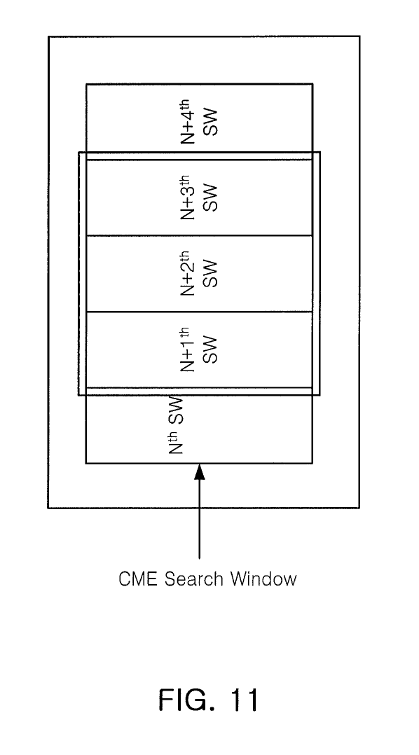

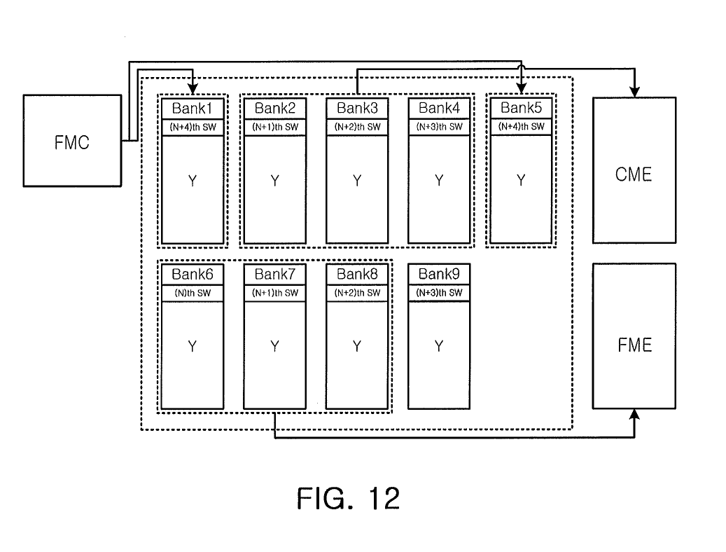

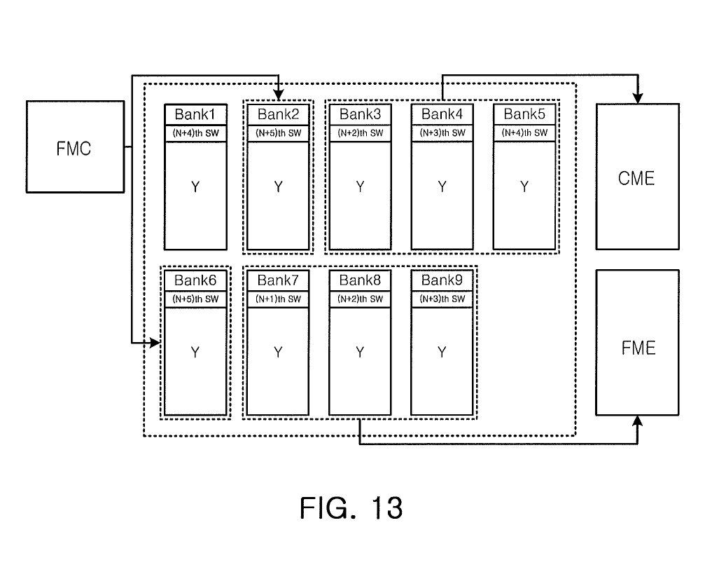

FIG. 11 is a diagram illustrating an operation of a first search window buffer according to an exemplary embodiment of the present invention. FIG. 12 is another diagram illustrating an operation of a first search window buffer according to an exemplary embodiment of the present invention. FIG. 13 is another diagram illustrating an operation of a first search window buffer according to an exemplary embodiment of the present invention.

Referring to FIG. 11, a first search window buffer 150 according to an exemplary embodiment of the present invention is configured to vertically divide a search window region of coarse motion estimation into three equal parts, and store only Y of one region in one bank. The first search window buffer 150 has 9 banks, and the frame memory controller, the coarse motion estimation and the fine motion estimation may simultaneously read/write a search window region of a unit macroblock.

If the search regions (SW I) of a reference frame for coarse motion estimation of the current macroblock are the (N+1)^{th} SW, the (N+2)^{th} SW and the (N+3)^{th} SW, the SW regions of the next macroblock are the (N+2)^{th} SW, the (N+3)^{th} SW and the (N+4)^{th} SW.

The frame memory controller continuously reads three SWs from the frame memory. The frame memory controller read one SW from the frame memory and writes the same in the first search window buffer. Also, coarse motion estimation reads three previous SWs. The frame memory controller read one SW from the frame memory and writes the same in the first search window buffer. Also, coarse motion estimation reads three previous SWS and fine motion estimation reads three previous SWs.

The frame memory controller reads the Y of the Nth SW from the SRAM0 and the SRAM5. The SRAM0 and the SRAM5 store the same contents. In this manner, the (N+1)^{th} SW, the (N+2)th SW, and the (N+3)^{th} SW are stored in the SRAM1, the SRAM6, the SRAM2, the SRAM7, the SRAM3, and the SRAM8. When the frame memory controller stores the (N+3)^{th} SW, the coarse motion estimation reads the SRAM0, the SRAM1 and the SRAM2 in order to read the search region (SW I) of a reference frame for coarse motion estimation, which correspond to the N^{th} SW, the (N+1)^{th} SW, and (N+2)^{th} SW.

Referring to FIG. 12, a next-step operation of the first search window buffer 150 according to an exemplary embodiment of the present invention is as follows. The frame memory controller stores (N+4)^{th} SW in the SRAM0 and the SRAM4. Also, the coarse motion estimation reads the SRAM1, the SRAM2 and the SRAM3 in order to read the search region (SW I) of a reference frame for coarse motion estimation, which correspond to the (N+1)^{th} SW, the (N+2)^{th} SW, and (N+3)^{th} SW.

The fine motion estimation reads the SRAM5, the SRAM6 and the SRAM7 storing the N^{th} SW, the (N+1)^{th} SW, and (N+2)^{th} SW in order to read a portion of the search window for fine motion estimation.

Referring to FIG. 13, a next-step operation of the first search window buffer 150 according to an exemplary embodiment of the present invention is as follows. The frame memory controller stores (N+5)^{th} SW in the SRAM1 and the SRAM5. Also, the coarse motion estimation reads the SRAM2, the SRAM3 and the SRAM4 in order to read the search region (SW I) of a reference frame for coarse motion estimation, which correspond to the (N+2)^{th} SW, the (N+3)^{th} SW, and (N+4)^{th} SW. The fine motion estimation reads the SRAM6, the SRAM7 and the SRAM8 storing the (N+1)^{th} SW, the (N+2)^{th} SW, and (N+3)^{th} SW in order to read a portion of the search window for fine motion estimation.

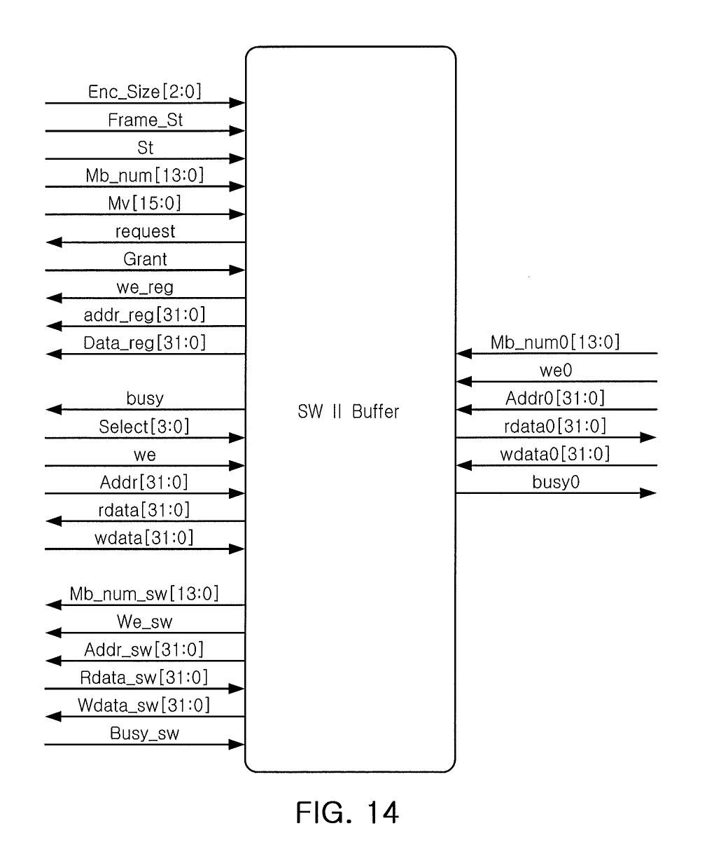

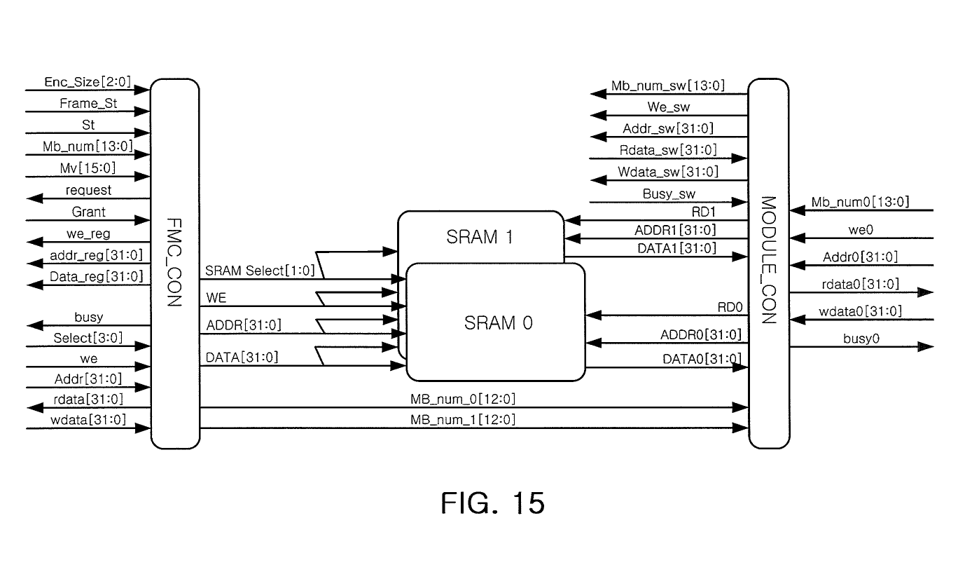

FIG. 14 is an interface diagram illustrating a second search window buffer according to an exemplary embodiment of the present invention. FIG. 15 is a block diagram of a second search window buffer according to an exemplary embodiment of the present invention.

Referring to FIGS. 14 and 15, a second search window buffer 160 according to an exemplary embodiment of the present invention is configured to store a search region (SW II) of a reference frame for fine motion estimation. The second search window buffer 160 may be configured to store the search regions of a reference frame other than those of the first search window buffer. The search regions of the reference frame other than those of the first search window buffer may vary according to the results of coarse motion estimation.

In general, the motion estimation for inter prediction of a video encoder designed in hardware performs hierarchical motion estimation, and the hierarchical motion estimation is divided into coarse motion estimation and fine motion estimation.

By coarse motion estimation, an optimal motion vector is determined by searching all the search window regions at intervals of large motion vector in a wide search window region. In fine motion estimation, on the basis of the optimal motion vector, motion estimation is performed on a ¼ pixel unit only in a peripheral search window region.

The search window region necessary for fine motion estimation much overlaps with the search window region necessary for coarse motion estimation. The non-overlapping search window region is called a search region (SW II) of a reference frame for fine motion estimation, and it is stored using the second search window buffer.

Thus, on the basis of the motion vector resulting from the coarse motion estimation, the search region (SW II) of the reference frame for fine motion estimation is read from the second search window buffer. For the SW necessary for fine motion estimation, a fine motion estimation operation is performed using the search region (SW II) of the reference frame for fine motion estimation and the search region (SW I) of the reference frame for coarse motion estimation read through the first search window buffer.

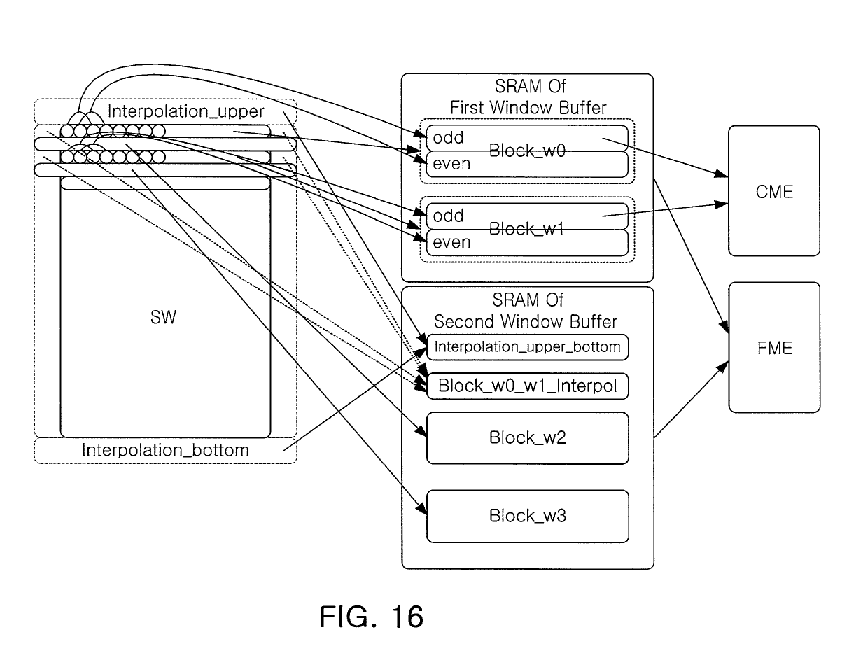

FIG. 16 is a diagram illustrating an operation of a second search window buffer according to an exemplary embodiment of the present invention.

Referring to FIG. 16, coarse motion estimation does not perform a motion prediction operation on pixels corresponding to a 16×16 matrix corresponding to a conventional macroblock size, but performs a motion prediction operation on pixels corresponding to an 8×8 matrix resulting from a ½ sampling operation. Therefore, data in the search window region also follow the characteristics of reading a macroblock buffer.

Thus, when the search window region is divided on a block basis, the SRAMs of the first search window buffer perform a storing operation so that only the first and second words among the four words are stored in the block_w0 and the block_w1 in the SRAM of the first search window buffer. The first and second pixels in the word are stored in an odd memory, the second and fourth pixels are stored in an even memory, and coarse motion estimation reads only an odd memory. An even memory stores data to be used for fine motion estimation.

The second search window buffer reads the second and fourth words of the necessary block according to the results of coarse motion estimation. They are respectively stored in the block_w2 and the block_w3. Also, a half-pel operation in fine motion estimation requires a region including three pixels up/down/left/right, in addition to the search window region.

It may be included in the first search window buffer, the block_w2 and the block_w3. However, if not, an upper region Interpolation_upper and a bottom region Interpolation_bottom are stored in the Interpolation_upper_bottom. Regions such as lines stored the block_w0 and the block_w1 among the left/right regions are stored in the Block_w0_w1_interpol.

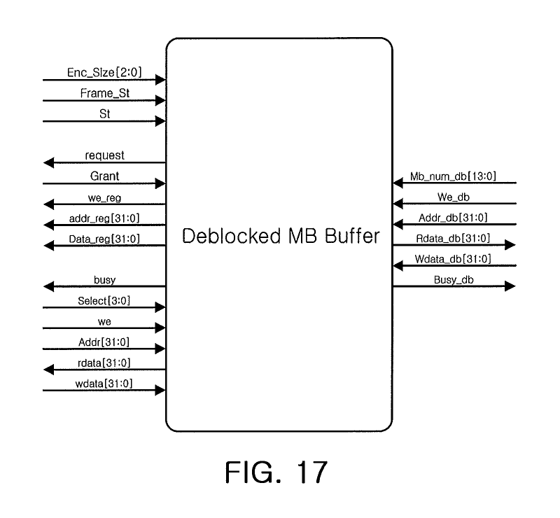

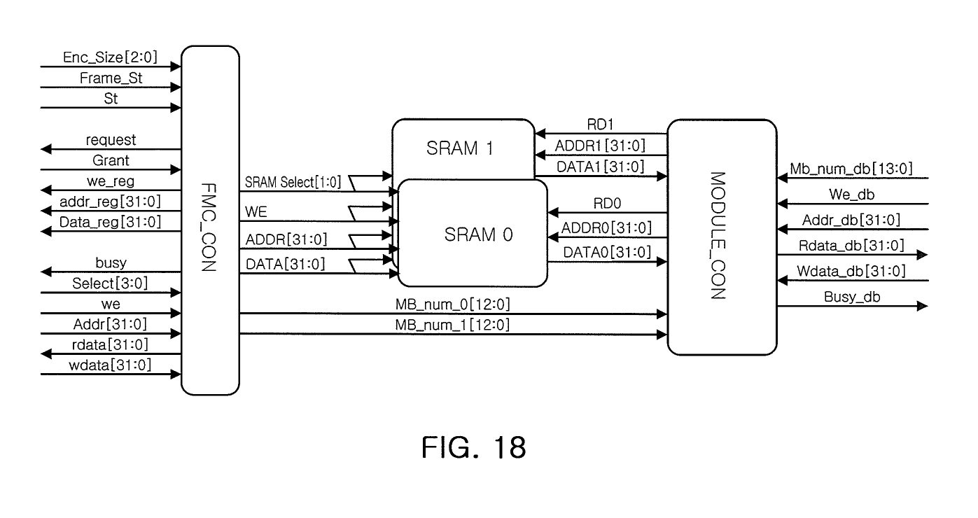

FIG. 17 is an interface diagram illustrating a deblocked macroblock (MB) buffer according to an exemplary embodiment of the present invention. FIG. 18 is a block diagram of a deblocked macroblock (MB) buffer according to an exemplary embodiment of the present invention.

Referring to FIGS. 17 and 18, a deblocked macroblock (MB) buffer 170 according to an exemplary embodiment of the present invention may be configured to store the performance results of a deblocking filter. The performance results of the deblocking filter in the deblocked macroblock buffer may also be stored in the frame memory.

The deblocked macroblock buffer 170 transforms/quantizes the difference between the encoded macroblock and the macroblock predicted by intra prediction or inter prediction. The deblocked macroblock buffer 170 stores the deblocked macroblock resulting from the performance results of the deblocking filter in order to remove a block phenomenon between macroblock units restored using the value resulting from inverse transformation and inverse quantization. Also, the already stored deblocked macroblock is stored in the frame memory through the frame memory controller.

Referring to FIGS. 17 and 18, the performance results of the deblocked filer are stored in an empty SRAM together with MB-num by a DB_CON. The filled SRAM sets the frame memory controller by the FMC_CON and it is stored in the frame memory.

In general, the number of SRAMs filling a macroblock may be N. This makes it possible to store N deblocked MBs in the frame memory, thus making it possible to store it in the frame memory after a macroblock processing time corresponding to (N−1).

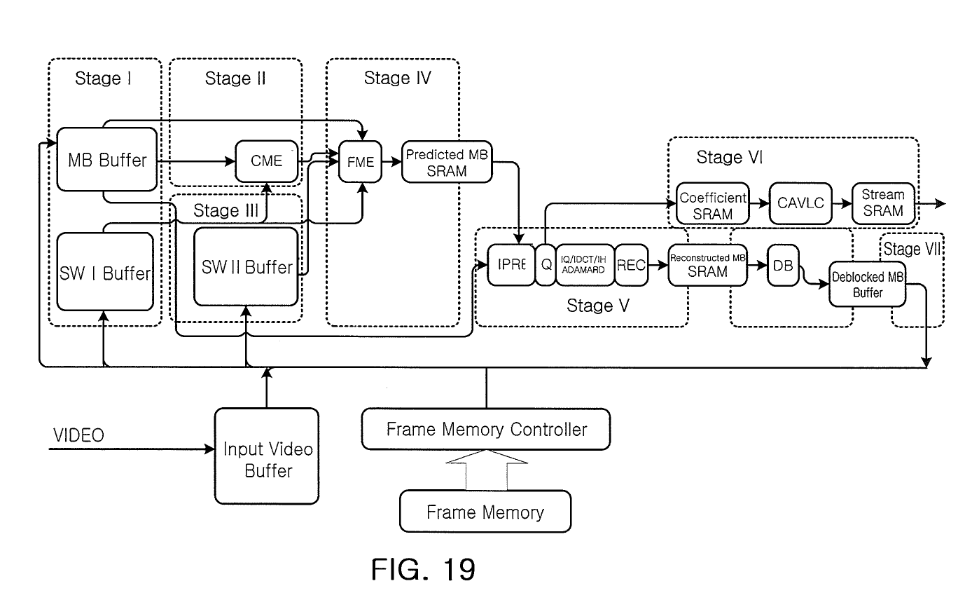

FIG. 19 is a diagram illustrating a stage-by-stage operation of a video processing system according to an exemplary embodiment of the present invention.

Referring to FIG. 19, the number of clocks for a macroblock-based process is compared, in the embodiments having a pipeline stage. In this structure, a factor determining a dominant pipeline stage may be a time taken to fill or empty the contents of the necessary buffer in each stage by the frame memory controller. Thus, the number of clocks for a macroblock-based process may be regarded as the number of clocks filling the buffer in each stage by the frame memory controller.

If the structure according to the present invention is not used, coarse motion estimation, intra prediction and fine motion estimation require different current macroblocks in different stages. Also, the effective pixels of the current macroblock required by intra prediction and fine motion estimation in the same stage may be different.

Therefore, the current macroblocks for intra prediction, coarse motion estimation and fine motion estimation should be stored therein, and the current macroblocks should be repetitively read through the frame memory controller.

Also, the contents of the first search window buffer are not referred to when filling the contents of the second search window buffer. Therefore, it should store all the YUV of a search range of fine motion estimation.

In general, the frame memory includes a SDRAM and has parameters of CAS Latency 3 and tRAC 7 in order to support a video size of 720 p or 1080 p. For read/write cycle measurement, tRAC is not measurement-dominated. Therefore, it is disregarded, and the performance may be compared with CAS latency 3.

TABLE 1

| Buffer in on-chip system | Non-inventive | Inventive |
|---|---|---|
| MB Buffer | 360 | 192 |
| SW I Buffer | 168 | 168 |
| SW II Buffer | 264 | 168.6 |
| Deblocked MB Buffer | 192.3 | 192.3 |
| SUM (Cycle/MB) | 984.3 | 720.9 |

Table 1 shows the comparison of the number of clocks necessary for each buffer and the number of clocks for a macroblock-based process.

The throughput (cycle/MB) of a pipeline is 984.3 cycles, while the throughput (cycle/MB) according to the inventive structure is 720.9 cycles. It can be seen that the number of clocks for a macroblock-based process by the throughput is 73.24% of the conventional one, that is, the number of clocks for a macroblock-based process by the throughput is reduced by approximately 26.76%.

As set forth above, according to the exemplary embodiments of the invention, the video processing system can simultaneously read a plurality of macroblocks, and can simultaneously perform a plurality of operations. In particular, the present invention can reduce the number of performance cycles per macroblock when the video processing system is configured in a pipeline structure. Therefore, the present invention can increase the number of macroblocks that can be processed within the same time period. Accordingly, the present invention makes it possible to process a multimedia video with more data in real time.

While the present invention has been shown and described in connection with the exemplary embodiments, it will be apparent to those skilled in the art that modifications and variations can be made without departing from the spirit and scope of the invention as defined by the appended claims.

What is claimed is:

1. A video processing system comprising:
a frame memory configured to store frame data;
an input video buffer configured to store input data and transfer the input data to the frame memory;
a macroblock (MB) buffer configured to store a plurality of macroblocks;
a first search window (SW) buffer configured to store a search region of a reference frame for coarse motion estimation (CME);
a second search window (SW) buffer configured to store a search region of a reference frame for fine motion estimation (FME);
a deblocked macroblock buffer configured to store the performance results of a deblocking filter; and
a frame memory controller configured to perform write/read operations on the input video buffer, the macroblock buffer, the first search window buffer, the second search window buffer, the deblocked macroblock buffer and the frame memory.

2. The video processing system of claim 1, wherein the frame memory comprises a synchronous dynamic random access memory (SDRAM).

3. The video processing system of claim 1, wherein the input video buffer stores the input data by dividing the input data by the number of macroblocks in a frame.

4. The video processing system of claim 1, wherein the macroblock buffer is configured to sequentially store a plurality of macroblocks read from the frame memory and to sequentially read the stored macroblocks.

5. The video processing system of claim 4, wherein the macroblock buffer comprises a plurality of memories, and each of the memories is configured to store the chroma and the luminance of a macroblock.

6. The video processing system of claim 1, wherein the size of a search region of each reference frame in the first search window buffer is variable.

7. The video processing system of claim 1, wherein the search regions of the reference frames are simultaneously read from the first search window buffer.

8. The video processing system of claim 1, wherein the second search window buffer stores the search regions of the reference frames other than those of the first search window buffer.

9. The video processing system of claim 8, wherein the search regions of the reference frames other than those of the first search window buffer vary according to the results of coarse motion estimation (CME).

10. The video processing system of claim 1, wherein the performance results of the deblocking filter in the deblocked macroblock buffer are stored in the frame memory.

11. The video processing system of claim 1, wherein the frame memory controller is configured to perform a data write/read operation on a macroblock basis.
